(19) United States
(12) Patent Application Publication
(10) Pub. No.: US 2014/0085203 A1
(43) Pub. Date: Mar. 27, 2014

(54) VIDEO IMAGE DISPLAY SYSTEM AND HEAD MOUNTED DISPLAY

(71) Applicant: SEIKO EPSON CORPORATION, Tokyo (JP)

(72) Inventor: Shinichi KOBAYASHI, Azumino-shi (JP)

(73) Assignee: SEIKO EPSON CORPORATION, Tokyo (JP)

(21) Appl. No.: 14/010,998

(22) Filed: Aug. 27, 2013

(30) Foreign Application Priority Data
Sep. 26, 2012 (JP) 2012-213016

(51) Int. Cl. G06F 3/01

(52) U.S. Cl. CPC G06F 3/012
USPC 345/158

(57) ABSTRACT

A video image display system including an information apparatus and a transmissive head mounted display that allows a user to visually recognize video images distributed from the information apparatus as virtual images is provided. The information apparatus includes a video image distributor that distributes video images corresponding to a specific geographic region to the head mounted display. The head mounted display includes a motion detector that detects motion of the user's head and allows the user to visually recognize, as virtual images, video images selected based on motion information representing the motion.

### BACKGROUND

1. Technical Field

The present invention relates to a video image display system and a head mounted display.

2. Related Art

There is a known head mounted display (HMD) that is a display mounted on the head. A head mounted display generates image light representing an image, for example, by using a liquid crystal display and a light source and guides the generated image light to user's eyes by using a projection system and a light guide plate to allow the user to visually recognize a virtual image. Such a head mounted display is classified into two types, a transmissive type in which the user can visually recognize an outside scene as well as a virtual image (optically transmissive type and video transmissive type) and a non-transmissive type in which the user cannot visually recognize an outside scene.

There is a known video image display system of related art that has cameras installed, for example, at a variety of places and on vehicles in a racing competition venue and transmits multiple sets of video images captured with the installed multiple cameras to non-transmissive head mounted displays to display video images selected by users who wear the head mounted displays through a user interface (for example, see JP-T-2002-539701)

The video image display system of related art described above has room for improvement in convenience of the user. For example, in the video image display system of related art described above, to select one set of video images from the multiple sets of video images and display the selected video images in any of the head mounted displays, the user needs to perform operation of selecting the one set of video images, which is cumbersome in some cases. Further, in the video image display system of related described above, since the selection of video images relies on the user, preferable video images according to the state of the user are not always selected. Moreover, since the video image display system of related art described above uses non-transmissive head mounted displays, no consideration is given to use of transmissive head mounted displays that allow visual recognition of an outside scene as well as a virtual image. Additionally, in a video image display system of related art and head mounted displays that form the system, size reduction, cost reduction, resource savings, ease of manufacture, improvement in usability, and other factors thereof have been desired. JP-A-7-95561 is exemplified as another related art document.

### SUMMARY

An advantage of some aspects of the invention is to solve at least a part of the problems described above, and the invention can be implemented as the following aspects.

(1) An aspect of the invention provides a video image display system including an information apparatus and a transmissive head mounted display that allows a user to visually recognize video images distributed from the information apparatus as virtual images. In the video image display system, the information apparatus includes a video image distributor that distributes video images corresponding to a specific geographic region to the head mounted display, and the head mounted display includes a motion detector that detects motion of the user's head and allows the user to visually recognize, as virtual images, the video images selected based on motion information representing the motion. The video image display system according to the aspect allows preferable video images according to the state of the user of the head mounted display to be selected and the selected video images to be visually recognized by the user without forcing the user to make cumbersome video image selection, whereby the convenience of the user can be enhanced.

(2) The video image display system according to the aspect described above may be configured such that the head mounted display includes an information transmitter that transmits the motion information to the information apparatus, the information apparatus includes an information receiver that receives the motion information from the head mounted display located in the specific geographic region, and the video image distributor selects at least one of the multiple sets of video images corresponding to the specific geographic region based on the motion information and distributes the selected video images to the head mounted display from which the motion information has been transmitted. The video image display system according to this aspect, in which the video image distributor of the information apparatus selects at least one set of video images based on the motion information and distributes the selected video images to the head mounted display from which the motion information has been transmitted, allows preferable video images according to the state of the user of the head mounted display to be selected without forcing the user to make cumbersome video image selection, whereby the convenience of the user can be enhanced.

(3) The video image display system according to the aspect described above may be configured such that the multiple sets of video images include replayed video images generated by capturing images of an object in the specific geographic region in a predetermined period, and when the motion of the user's head represented by the motion information is greater than or equal to a threshold set in advance, the video image distributor selects the replayed video images corresponding to a period determined based on the motion information. Since the video image display system according to this aspect selects replayed video images corresponding to a period determined based on the motion information and distributes the selected replayed video images to the head mounted display, the user is allowed to visually recognize replayed video images generated when the user moves the head by an amount greater than or equal to the threshold, whereby the convenience of the user can be further enhanced.

(4) The video image display system according to the aspect described above may be configured such that the replayed video images are visually recognized in a position closer to the center of the field of view of the user of the head mounted display than the other video images. The video image display system according to this aspect allows the user to visually recognize replayed video images generated when the user moves the head by an amount greater than or equal to the threshold in a position close to the center of the field of view of the user, whereby the convenience of the user can be further enhanced.

(5) The video image display system according to the aspect described above may be configured such that the replayed video images are displayed in the field of view of the user of the head mounted display in at least one of the manners that the replayed video images are enlarged, the replayed video images are enhanced, and the replayed video images are provided with a predetermined mark, as compared with the other video images. The video image display system according to this aspect allows the user to visually recognize replayed video images generated when the user moves the head by an amount greater than or equal to the threshold in a highly visible manner, whereby the convenience of the user can be further enhanced.

(6) The video image display system according to the aspect described above may be configured such that the video image distributor stops distributing video images for a predetermined period to the head mounted display from which the motion information has been transmitted when the motion of the user's head represented by the motion information is greater than or equal to a threshold set in advance. The video image display system according to this aspect does not allow the user to visually recognize any virtual image in the field of view of the user but allows the user to directly visually recognize an outside scene in a large area of the field of view when the user moves the head by an amount greater than or equal to the threshold, whereby the convenience of the user can be further enhanced.

(7) The video image display system according to the aspect described above may be configured such that the multiple sets of video images are generated by capturing images of an object in the specific geographic region, the head mounted display further includes a position detector that detects a current position, the information transmitter transmits positional information representing the current position to the information apparatus, and the video image distributor selects video images based on the motion information and the positional information. The video image display system according to this aspect allows preferable video images according to the state of the user to be selected and the selected video images to be visually recognized by the user, whereby the convenience of the user can be enhanced.

(8) The video image display system according to the aspect described above may be configured such that the video image distributor selects video images generated by capturing images of an object at an angle different from the angle of a line of sight of the user of the head mounted display estimated based on the motion information and the positional information by at least a predetermined value. The video image display system according to this aspect allows the user to visually recognize video images generated by capturing an object at an angle different from the angle of an estimated line of sight of the user by at least a predetermined value, whereby the convenience of the user can be further enhanced.

(9) The video image display system according to the aspect described above may be configured such that the video image distributor selects video images generated by capturing images of an object located outside a predetermined area in a field of view of the user of the head mounted display estimated based on the motion information and the positional information. The video image display system according to this aspect allows the user to visually recognize video images generated by capturing images of an object located outside a predetermined area in an estimated field of view of the user, whereby the convenience of the user can be further enhanced.

(10) The video image display system according to the aspect described above may be configured such that the head mounted display in the specific geographic region includes a video image receiver that receives the multiple sets of video images corresponding to the specific geographic region from the information apparatus and a video image selector that selects video images to be visually recognized by the user from the multiple sets of video images based on the motion information. The video image display system according to this aspect, in which the video image selector in the head mounted display selects video images based on the motion information, and the selected video images are visually recognized by the user, allows preferable video images according to the state of the user of the head mounted display to be selected without forcing the user to make cumbersome video image selection, whereby the convenience of the user can be enhanced.

(11) Another aspect of the invention provides a transmissive head mounted display to which an information apparatus distributes video images corresponding to a specific geographic region and which allows a user to visually recognize the distributed video images as virtual images. The head mounted display includes a motion detector that detects motion of the user's head and allows the user to visually recognize, as virtual images, the video images selected based on motion information representing the motion. The head mounted display according to the aspect allows preferable video images according to the state of the user of the head mounted display to be selected and the selected video images to be visually recognized by the user without forcing the user to make cumbersome video image selection, whereby the convenience of the user can be enhanced.

(12) Still another aspect of the invention provides a video image display system including an information apparatus and a transmissive head mounted display that allows a user to visually recognize video images distributed from the information apparatus as virtual images. In the video image display system, the head mounted display includes a position detector that detects a current position and an information transmitter that transmits positional information representing the current position to the information apparatus. The information apparatus includes an information receiver that receives the positional information from the head mounted display located in a specific geographic region and a video image distributor that selects at least one of the multiple sets of video images corresponding to the specific geographic region based on the positional information and distributes the selected video images to the head mounted display from which the positional information has been transmitted. The video image display system according to the aspect, in which the video image distributor of the information apparatus selects at least one set of video images based on the positional information and distributes the selected video images to the head mounted display from which the positional information has been transmitted, allows preferable video images according to the state of the user of the head mounted display to be selected without forcing the user to make cumbersome video image selection, whereby the convenience of the user can be enhanced.

Not all the plurality of components in the aspects of the invention described above are essential, and part of the plurality of components can be changed, omitted, or replaced with new other components as appropriate, or part of the limiting conditions can be omitted as appropriate in order to achieve part or all of the advantageous effects described herein. Further, in order to solve part or all of the problems described above or achieve part or all of the advantageous effects described herein, part or all of the technical features contained in an aspect of the invention described above can be combined with part or all of the technical features contained in another aspect of the invention described above to form an independent aspect of the invention.

The invention can be implemented in a variety of aspects in addition to the video image display system. For example, the invention can be implemented in the form of a head mounted display, an information apparatus, a content server, a method for controlling these apparatuses and the server, a computer program that achieves the control method, and a non-transitory storage medium on which the computer program is stored.

### BRIEF DESCRIPTION OF THE DRAWINGS

The invention will be described with reference to the accompanying drawings, wherein like numbers reference like elements.

FIG. 1 is a descriptive diagram showing a schematic configuration of a video image display system 1000 in a first embodiment of the invention.

FIG. 2 is a descriptive diagram showing an exterior configuration of a head mounted display 100.

FIG. 3 is a block diagram showing a functional configuration of the head mounted display 100.

FIG. 4 is a descriptive diagram showing how an image light generation unit outputs image light.

FIG. 5 is a descriptive diagram showing an example of a virtual image recognized by a user.

FIG. 6 is a flowchart showing the procedure of an automatic video image selection process.

FIGS. 7A to 7C are descriptive diagrams showing a summary of the automatic video image selection process.

FIG. 8 is a flowchart showing the procedure of an automatic video image selection process in a second embodiment.

FIGS. 9A to 9C are descriptive diagrams showing a summary of the automatic video image selection process in the second embodiment.

### DESCRIPTION OF EXEMPLARY EMBODIMENTS

### A. First Embodiment

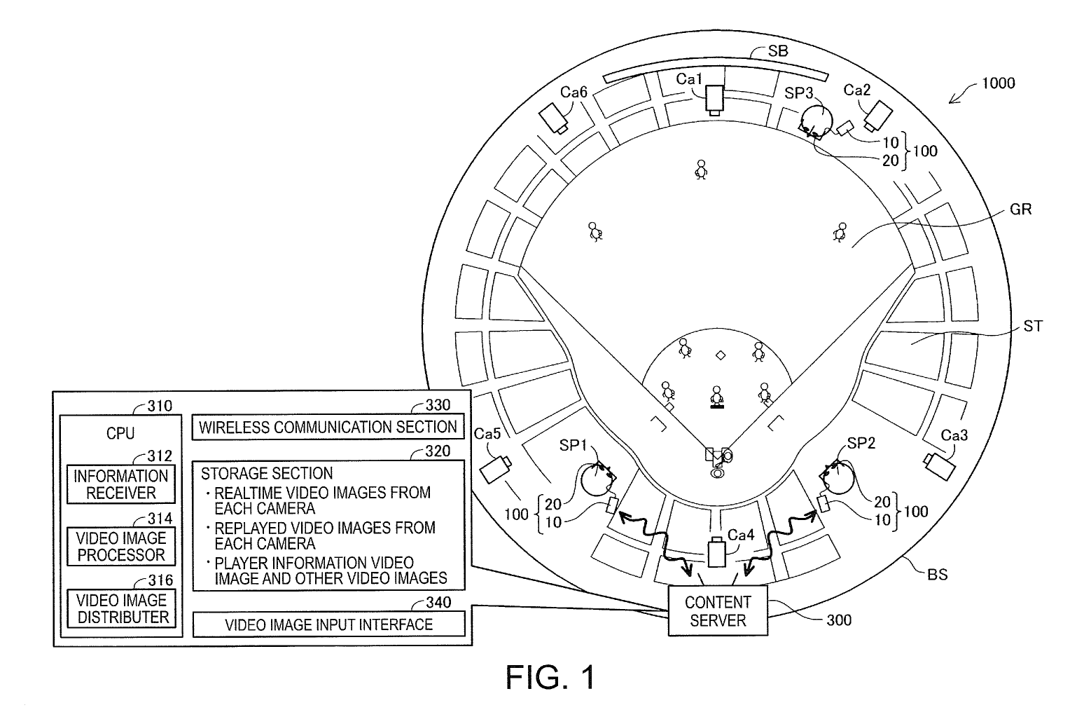

FIG. 1 is a descriptive diagram showing a schematic configuration of a video image display system 1000 in a first embodiment of the invention. The video image display system 1000 in the present embodiment is a system used in a baseball stadium BS. In the example shown in FIG. 1, spectators SP who each wear a head mounted display 100 (which will be described later in detail) are watching a baseball game in a watching area ST provided around a ground GR of the baseball stadium BS.

The video image display system 1000 includes a content server 300. The content server 300 includes a CPU 310, a storage section 320, a wireless communication section 330, and a video image input interface 340. The storage section 320 is formed, for example, of a ROM, a RAM, a DRAM, and a hard disk drive. The CPU 310, which reads and executes a computer program stored in the storage section 320, functions as an information receiver 312, a video image processer 314, and a video image distributor 316. The wireless communication section 330 wirelessly communicates with the head mounted displays 100 present in the baseball stadium BS in accordance with a predetermined wireless communication standard, such as a wireless LAN and Bluetooth. The wireless communication between the content server 300 and the head mounted displays 100 may alternatively be performed via a communication device (wireless LAN access point, for example) provided as a separate device connected to the content server 300. In this case, the wireless communication section 330 in the content server 300 can be omitted. Further, the content server 300 can be installed at an arbitrary place inside or outside the baseball stadium BS as long as the content server 300 can wirelessly communicate directly or via the communication device with the head mounted displays 100 present in the baseball stadium BS.

In the baseball stadium BS, a plurality of cameras Ca, which capture images of a variety of objects in the baseball stadium BS (such as ground GR, players, watching area ST, spectators, and scoreboard SB), are installed. For example, in the example shown in FIG. 1, the following cameras are installed in the baseball stadium BS: a camera Ca4 in the vicinity of the back of a backstop; cameras Ca3 and Ca5 close to infield seats; and cameras Ca1, Ca2, and Ca6 close to outfield seats. The number and layout of cameras Ca installed in the baseball stadium BS are arbitrarily changeable. Each of the cameras Ca is connected to the content server 300 via a cable and a relay device, the latter of which is provided as required, and video images captured with each of the cameras Ca are inputted to the video image input interface 340 of the content server 300. The video image processor 314 of the content server 300 performs compression and other types of processing as required on the inputted video images and stores the processed video images as realtime video images from each of the cameras Ca in the storage section 320. The realtime video images are substantially live broadcast video images to the head mounted displays 100. The video image processor 314 further generates replayed video images from the inputted video images and stores the generated video images in the storage section 320. The replayed video images are those representing a scene in a past predetermined period (highlight scene). Further, in the present embodiment, the storage section 320 stores in advance information on the players (such as names of players, name of team that players belong to, territories of players, performance of players) and information on the baseball stadium BS (such as name of baseball stadium, capacity thereof, number of current spectators therein, and weather therearound). The connection between each of the cameras Ca and the content server 300 is not necessarily wired connection but may be wireless connection.

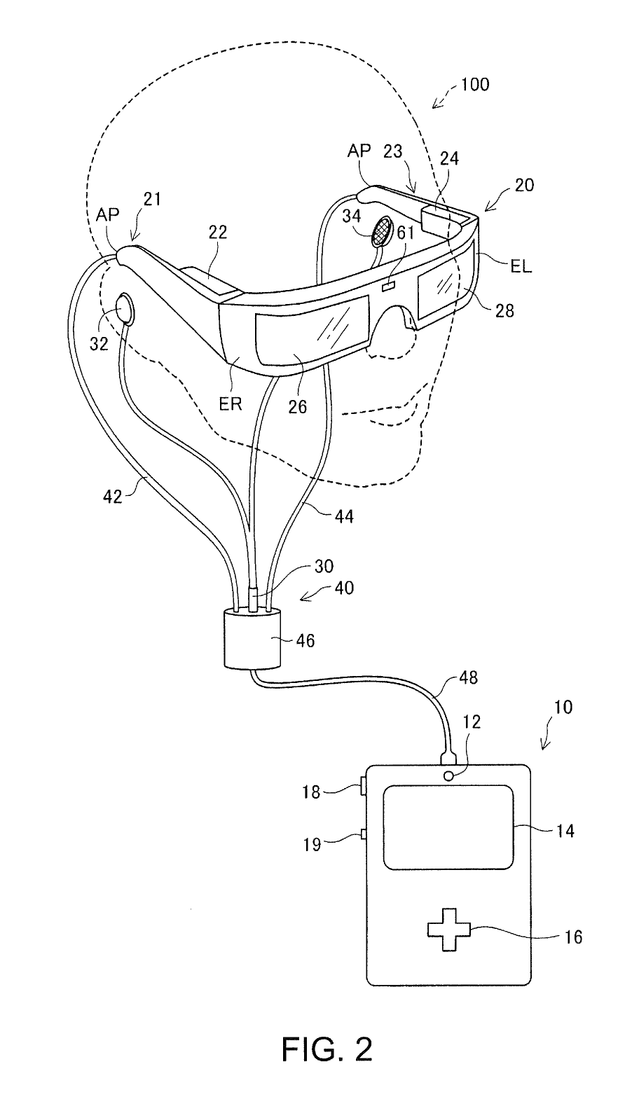

FIG. 2 is a descriptive diagram showing an exterior configuration of each of the head mounted displays 100. Each of the head mounted displays 100 is a display mounted on the head and also called HMD. Each of the head mounted displays 100 in the present embodiment is an optically transmissive head mounted display that allows a user to not only visually recognize a virtual image but also directly visually recognize an outside scene.

The head mounted display 100 includes an image display unit 20, which allows the user who wears the head mounted display 100 around the head to visually recognize a virtual image, and a control unit (controller) 10, which controls the image display unit 20.

The image display unit 20 is a mounting member mounted on the head of the user and has a glasses-like shape in the present embodiment. The image display unit 20 includes a right holder 21, a right display driver 22, a left holder 23, a left display driver 24, a right optical image display section 26, a left optical image display section 28, and a camera 61. The right optical image display section 26 and the left optical image display section 28 are so disposed that they are located in front of the user's right and left eyes respectively when the user wears the image display unit 20. One end of the right optical image display section 26 and one end of the left optical image display section 28 are connected to each other in a position corresponding to the portion between the eyebrows of the user who wears the image display unit 20.

The right holder 21 is a member extending from an end ER of the right optical image display section 26, which is the other end thereof, to a position corresponding to the right temporal region of the user who wears the image display unit 20. Similarly, the left holder 23 is a member extending from an end EL of the left optical image display section 28, which is the other end thereof, to a position corresponding to the left temporal region of the user who wears the image display unit 20. The right holder 21 and the left holder 23 serve as if they were temples (sidepieces) of glasses and hold the image display unit 20 around the user's head.

The right display driver 22 is disposed in a position inside the right holder 21, in other words, on the side facing the head of the user who wears the image display unit 20. The left display driver 24 is disposed in a position inside the left holder 23. In the following description, the right holder 21 and the left holder 23 are collectively and simply also called “holders,” the right display driver 22 and the left display driver 24 are collectively and simply also called “display drivers,” and the right optical image display section and the left optical image display section 28 are collectively and simply also called “optical image display sections.”

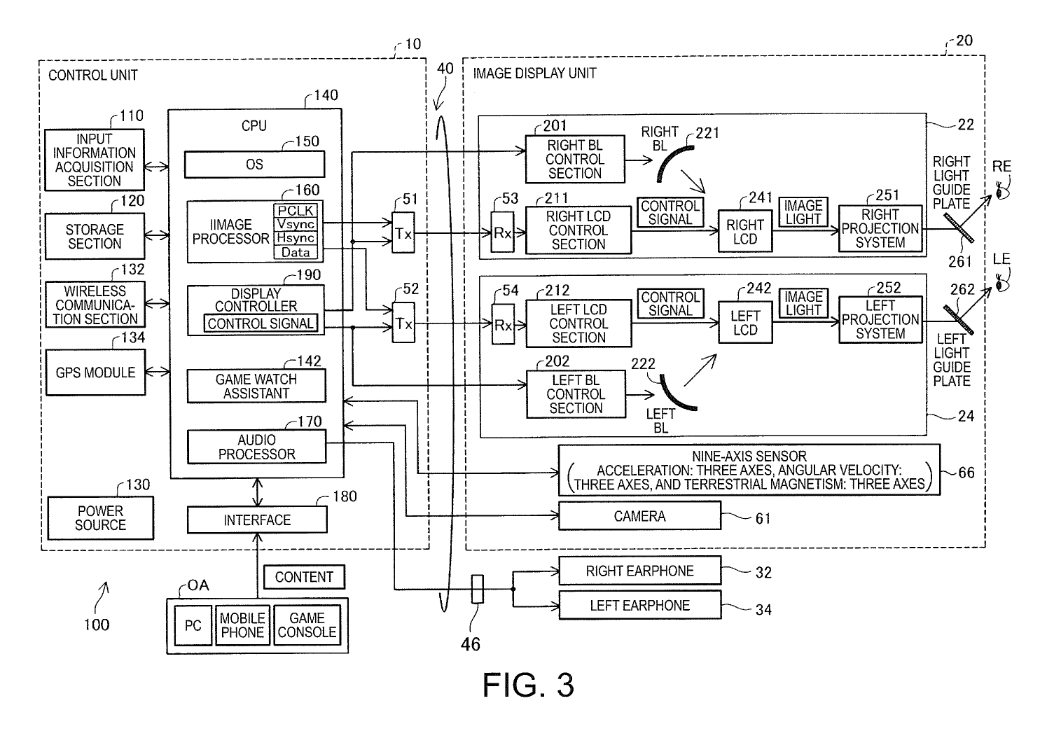

The display drivers 22 and 24 include liquid crystal displays (hereinafter referred to as “LCDs”) 241 and 242 and projection systems 251 and 252 (see FIG. 3). The configuration of the display drivers 22 and 24 will be described later in detail. The optical image display sections 26 and 28 as optical members include light guide plates 261 and 262 (see FIG. 3) and light control plates. The light guide plates 261 and 262 are made, for example, of a light transmissive resin material and guide image light outputted from the display drivers 22 and 24 to the user's eyes. The light control plates are each a thin-plate-shaped optical element and so disposed that they cover the front side of the image display unit 20 (side facing away from user's eyes). The light control plates prevent the light guide plates 261 and 262 from being damaged, prevent dust from adhering thereto, and otherwise protect the light guide plates 261 and 262. Further, the amount of external light incident on the user's eyes can be adjusted by adjusting light transmittance of the light control plates, whereby the degree of how comfortably the user visually recognizes a virtual image can be adjusted. The light control plates can be omitted.

The camera 61 is disposed in a position corresponding to the portion between the eyebrows of the user who wears the image display unit 20. The camera 61 captures an image of an outside scene in front of the image display unit 20, in other words, on the side opposite to the user's eyes to acquire an outside scene image. The camera 61 is a monocular camera in the present embodiment and may alternatively be a stereoscopic camera.

The image display unit 20 further includes a connecting section 40 that connects the image display unit 20 to the control unit 10. The connecting section 40 includes a main body cord 48, which is connected to the control unit 10, a right cord 42 and a left cord 44, which are bifurcated portions of the main body cord 48, and a coupling member 46 provided at a bifurcating point. The right cord 42 is inserted into an enclosure of the right holder 21 through an end AP thereof, which is located on the side toward which the right holder 21 extends, and connected to the right display driver 22. Similarly, the left cord 44 is inserted into an enclosure of the left holder 23 through an end AP thereof, which is located on the side toward which the left holder 23 extends, and connected to the left display driver 24. The coupling member 46 is provided with a jack to which an earphone plug 30 is connected. A right earphone 32 and a left earphone 34 extend from the earphone plug 30.

The image display unit 20 and the control unit 10 transmit a variety of signals to each other via the connecting section 40. The end of the main body cord 48 that faces away from the coupling member 46 is provided with a connector (not shown), which fits into a connector (not shown) provided in the control unit 10. The control unit 10 and the image display unit 20 are connected to and disconnected from each other by engaging and disengaging the connector on the main body cord 48 with and from the connector on the control unit 10. Each of the right cord 42, the left cord 44, and the main body cord 48 can, for example, be a metal cable or an optical fiber.

The control unit 10 is a device that controls the head mounted display 100. The control unit 10 includes a light-on section 12, a touch pad 14, a cross-shaped key 16, and a power switch 18. The light-on section 12 notifies the user of the action state of the head mounted display 100 (whether it is powered on or off, for example) by changing its light emission state. The light-on section 12 can, for example, be an LED (light emitting diode). The touch pad 14 detects contact operation performed on an operation surface of the touch pad 14 and outputs a signal according to a detection result. The touch pad 14 can be an electrostatic touch pad, a pressure detection touch pad, an optical touch pad, or any of a variety of other touch pads. The cross-shaped key 16 detects press-down operation performed on the portions of the key that correspond to the up, down, right, and left directions and outputs a signal according to a detection result. The power switch 18 detects slide operation performed on the switch and switches the state of a power source in the head mounted display 100 from one to the other.

FIG. 3 is a block diagram showing a functional configuration of the head mounted display 100. The control unit 10 includes an input information acquisition section 110, a storage section 120, a power source 130, a wireless communication section 132, a GPS module 134, a CPU 140, an interface 180, and transmitters (Txs) 51 and 52, which are connected to one another via a bus (not shown).

The input information acquisition section 110 acquires a signal, for example, according to an operation input to any of the tough pad 14, the cross-shaped key 16, and the power switch 18. The storage section 120 is formed, for example, of a ROM, a RAM, a DRAM, and a hard disk drive. The power source 130 supplies the components in the head mounted display 100 with electric power. The power source 130 can, for example, be a secondary battery. The wireless communication section 132 wirelessly communicates with the content server 300 and other components in accordance with a predetermined wireless communication standard, such as a wireless LAN and Bluetooth. The GPS module 134 receives a signal from a GPS satellite to detect the current position of the GPS module 134 itself.

The CPU 140, which reads and executes a computer program stored in the storage section 120, functions as an operating system (OS) 150, an image processor 160, an audio processor 170, a display controller 190, and a game watch assistant 142.

The image processor 160 generates a clock signal PCLK, a vertical sync signal VSync, a horizontal sync signal HSync, image data Data based on a content (video images) inputted via the interface 180 or the wireless communication section 132 and supplies the image display unit 20 with the signals via the connecting section 40. Specifically, the image processor 160 acquires an image signal contained in the content. The acquired image signal, when it carries motion images, for example, is typically an analog signal formed of 30 frame images per second. The image processor 160 separates the vertical sync signal VSync, the horizontal sync signal HSync, and other sync signals from the acquired image signal. The image processor 160 further generates the clock signal PCLK by using a PLL (phase locked loop) circuit and other components (not shown) in accordance with the cycles of the separated vertical sync signal VSync and horizontal sync signal HSync.

The image processor 160 converts the analog image signal from which the sync signals have been separated into a digital image signal by using an A/D conversion circuit and other components (not shown). The image processor 160 then stores the converted digital image signal as the image data Data (RGB data) on an image of interest on a frame basis in the DRAM in the storage section 120. The image processor 160 may perform a resolution conversion process, a variety of color tone correction processes, such as luminance adjustment and chroma adjustment, a keystone correction process, and other types of image processing as required.

The image processor 160 transmits the generated clock signal PCLK, vertical sync signal VSync and horizontal sync signal HSync, and the image data Data stored in the DRAM in the storage section 120 via the transmitters 51 and 52, respectively. The image data Data transmitted via the transmitter 51 is also called “image data for the right eye,” and the image data Data transmitted via the transmitter 52 is also called “image data for the left eye.” The transmitters 51 and 52 function as transceivers for serial transmission between the control unit 10 and the image display unit 20.

The display controller 190 generates control signals that control the right display driver 22 and the left display driver 24. Specifically, the display controller 190 controls the image light generation and output operation performed by the right display driver 22 and the left display driver 24 by controlling the following operations separately based on control signals: ON/OFF driving of a right LCD 241 performed by a right LCD control section 211; ON/OFF driving of a right backlight 221 performed by a right backlight control section 201; ON/OFF driving of a left LCD 242 performed by a left LCD control section 212; and ON/OFF driving of a left backlight 222 performed by a left backlight control section 202. For example, the display controller 190 instructs both the right display driver 22 and the left display driver 24 to generate image light, only one of them to generate image light, or none of them to generate image light.

The display controller 190 transmits control signals to the right LCD control section 211 and the left LCD control section 212 via the transmitters 51 and 52, respectively. The display controller 190 further transmits control signals to the right backlight control section 201 and the left backlight control section 202.

The audio processor 170 acquires an audio signal contained in the content, amplifies the acquired audio signal, and supplies the amplified audio signal to a loudspeaker (not shown) in the right earphone 32 connected to the coupling member 46 and a loudspeaker (not shown) in the left earphone 34 connected to the coupling member 46. For example, when a Dolby® system is employed, the audio signal is processed, and the right earphone 32 and the left earphone 34 output different sounds, for example, having different frequencies. The game watch assistant 142 is an application program for assisting the user in watching a baseball game in the baseball stadium BS.

The interface 180 connects a variety of external apparatuses OA, from which contents are supplied, to the control unit 10. Examples of the external apparatus OA include a personal computer PC, a mobile phone terminal, and a game console. The interface 180 can, for example, be a USB interface, a micro-USB interface, and a memory card interface.

The image display unit 20 includes the right display driver 22, the left display driver 24, the right light guide plate 261 as the right optical image display section 26, the left light guide plate 262 as the left optical image display section 28, the camera 61, and a nine-axis sensor 66.

The nine-axis sensor 66 is a motion sensor that detects acceleration (three axes), angular velocity (three axes), and terrestrial magnetism (three axes). The nine-axis sensor 66, which is provided in the image display unit 20, functions as a motion detector that detects motion of the head of the user who wears the image display unit 20 around the head. The motion of the head used herein includes the velocity, acceleration, angular velocity, orientation, and a change in the orientation of the head. The game watch assistant 142 of the control unit 10 supplies the content server 300 via the wireless communication section 132 with positional information representing the current position of the control unit 10 detected with the GPS module 134 and motion information representing motion of the user's head detected with the nine-axis sensor 66. In this process, the game watch assistant 142 functions as an information transmitter in the appended claims.

The right display driver 22 includes a receiver (Rx) 53, the right backlight (BL) control section 201 and the right backlight (BL) 221, which function as a light source, the right LCD control section 211 and the right LCD 241, which function as a display device, and the right projection system 251. The right backlight control section 201, the right LCD control section 211, the right backlight 221, and the right LCD 241 are also collectively called an “image light generation unit.”

The receiver 53 functions as a receiver that performs serial transmission between the control unit 10 and the image display unit 20. The right backlight control section 201 drives the right backlight 221 based on an inputted control signal. The right backlight 221 is, for example, a light emitter, such as an LED, an electro-luminescence (EL) device. The right LCD control section 211 drives the right LCD 241 based on the clock signal PCLK, the vertical sync signal VSync, the horizontal sync signal HSync, and the image data for the right eye Data1 inputted via the receiver 53. The right LCD 241 is a transmissive liquid crystal panel having a plurality of pixels arranged in a matrix.

The right projection system 251 is formed of a collimator lens that converts the image light outputted from the right LCD 241 into a parallelized light flux. The right light guide plate 261 as the right optical image display section 26 reflects the image light outputted through the right projection system 251 along a predetermined optical path and guides the image light to the user's right eye RE. The right projection system 251 and the right light guide plate 261 are also collectively called a “light guide unit.”

The left display driver 24 has the same configuration as that of the right display driver 22. That is, the left display driver 24 includes a receiver (Rx) 54, the left backlight (BL) control section 202 and the left backlight (BL) 222, which function as a light source, the left LCD control section 212 and the left LCD 242, which function as a display device, and the left projection system 252. The left backlight control section 202, the left LCD control section 212, the left backlight 222, and the left LCD 242 are also collectively called an “image light generation unit.” The left projection system 252 is formed of a collimator lens that converts the image light outputted from the left LCD 242 into a parallelized light flux. The left light guide plate 262 as the left optical image display section 28 reflects the image light outputted through the left projection system 252 along a predetermined optical path and guides the image light to the user's left eye LE. The left projection system 252 and the left light guide plate 262 are also collectively called a “light guide unit.”

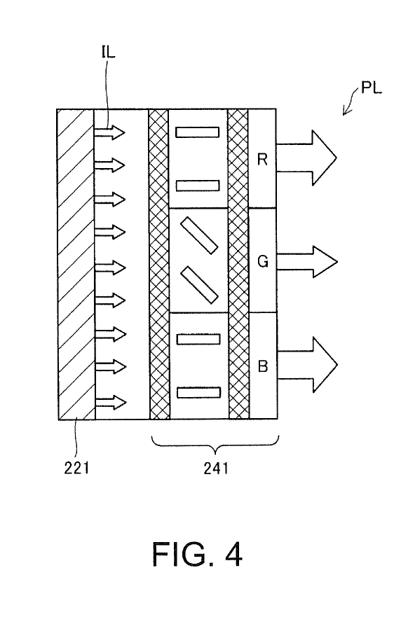

FIG. 4 is a descriptive diagram showing how the image light generation unit outputs image light. The right LCD 241 drives the liquid crystal material in the position of each of the pixels arranged in a matrix to change the transmittance at which the right LCD 241 transmits light to modulate illumination light IL that comes from the right backlight 221 into effective image light PL representing an image. The same holds true for the left side. The backlight-based configuration is employed in the present embodiment as shown in FIG. 4, but a front-light-based configuration or a configuration in which image light is outputted based on reflection may be used.

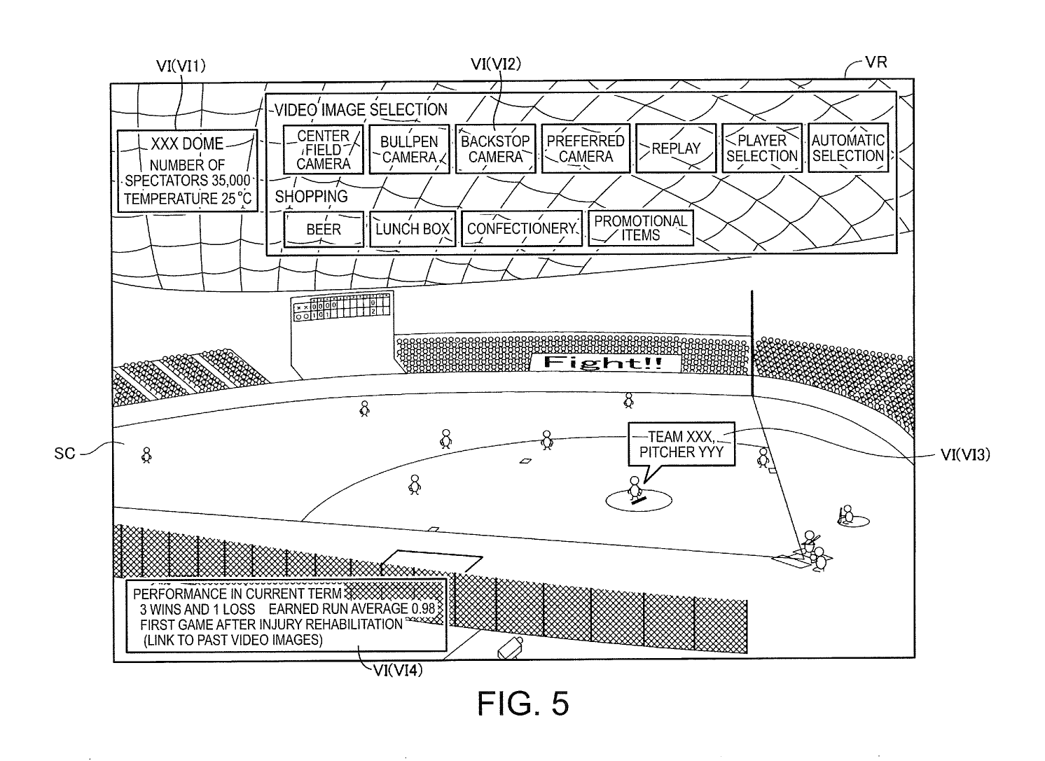

FIG. 5 is a descriptive diagram showing an example of a virtual image recognized by the user. FIG. 5 shows an example of a field of view VR of a spectator SP1 shown in FIG. 1. When image light guided to the eyes of the user (spectator SP) of the head mounted display 100 is focused on the user's retina, the user visually recognizes a virtual image VI. Further, in the portion of the field of view VR of the user other than the portion where the virtual image VI is displayed, the user visually recognizes an outside scene SC through the right optical image display section 26 and the left optical image display section 28. In the example shown in FIG. 5, the outside scene SC is a scene in the baseball stadium BS. In the head mounted display 100 according to the present embodiment, the user can visually recognize the outside scene SC also through the virtual image VI in the field of view VR.

In the present embodiment, when the user (spectator SP) of any of the head mounted displays 100 activates a predetermined application program in the baseball stadium BS, the CPU 140 functions as the game watch assistant 142 (FIG. 3) and displays the virtual image VI shown in FIG. 5 based on the function of the game watch assistant 142. That is, the game watch assistant 142 requests video images from the content server 300 via the wireless communication section 132 and displays the virtual image VI based on the video images distributed from the content server 300 that has responded to the request. The virtual image VI shown in FIG. 5 contains a sub-virtual image VI1 showing information on the baseball stadium BS (such as name of baseball stadium, number of spectators, and weather), a sub-virtual image VI2 showing a menu, and sub-virtual images VI3 and VI4 showing information on a player (such as name of player, name of team that player belongs to, territory of player, and performance of player). It can be said that video images representing the information on a player and video images representing the information on the baseball stadium BS are those corresponding to the baseball stadium BS as a specific geographic region. Part or the entire of the virtual image VI may alternatively be displayed based on video images stored in advance in the storage section 120 in the head mounted display 100.

The sub-virtual image VI2 showing a menu contains a plurality of icons for video image selection and a plurality of icons for shopping. For example, when the user operates the touch pad 14 or the cross-shaped key 16 on the control unit 10 to select one of the plurality of icons for shopping (beer icon, for example), the game watch assistant 142 transmits a purchase request for the item corresponding to the selected icon to a sales server (not shown) along with positional information representing the current position detected with the GPS module 134. The sales server forwards the received purchase request to a terminal in a shop that sells the item. A sales clerk in the shop responds to the purchase request forwarded to the terminal and delivers the requested item to a seat identified by the positional information.

The plurality of icons for video image selection in the sub-virtual image VI2 are formed of an icon for camera selection, an icon for replayed video image selection, an icon for player selection, and an icon for automatic selection. For example, when the user selects the icon for player selection and further selects a player of interest, the game watch assistant 142 of the head mounted display 100 transmits information that identifies the player to the content server 300 via the wireless communication section 132. The operation of selecting a player of interest is performed by using the touch pad 14 or the cross-shaped key 16 on the control unit 10. The selection operation may alternatively be automatically performed based on a value detected with the nine-axis sensor 66 when the user directs the line of sight toward a specific player. The video image distributor 316 of the content server 300 selects player information video images identified by the received information, reads the video images from the storage section 320, and distributes the read video images to the head mounted display 100 via the wireless communication section 330. The game watch assistant 142 of the head mounted display 100 displays the distributed video images as the virtual image VI.

Further, for example, when the user selects the button corresponding to a desired camera (camera Ca1 (center field camera) in FIG. 1, for example), the game watch assistant 142 of the head mounted display 100 transmits information that identifies the selected camera to the content server 300 via the wireless communication section 132. The video image distributor 316 of the content server 300 selects realtime video images captured with the camera identified by the received information, reads the video images from the storage section 320, and distributes the read video images to the head mounted display 100 via the wireless communication section 330. The game watch assistant 142 of the head mounted display 100 displays the distributed video images as the virtual image VI. The user can thus visually recognize video images captured at an angle and a zoom factor according to preference of the user as the virtual image VI.

Similarly, when the user selects the replay button, the game watch assistant 142 of the head mounted display 100 transmits a request for replayed video images to the content server 300 via the wireless communication section 132. The video image distributor 316 of the content server 300 selects the replayed video images, reads the video images from the storage section 320, and distributes the read video images to the head mounted display 100 via the wireless communication section 330. The game watch assistant 142 of the control unit 10 displays the distributed video images as the virtual image VI.

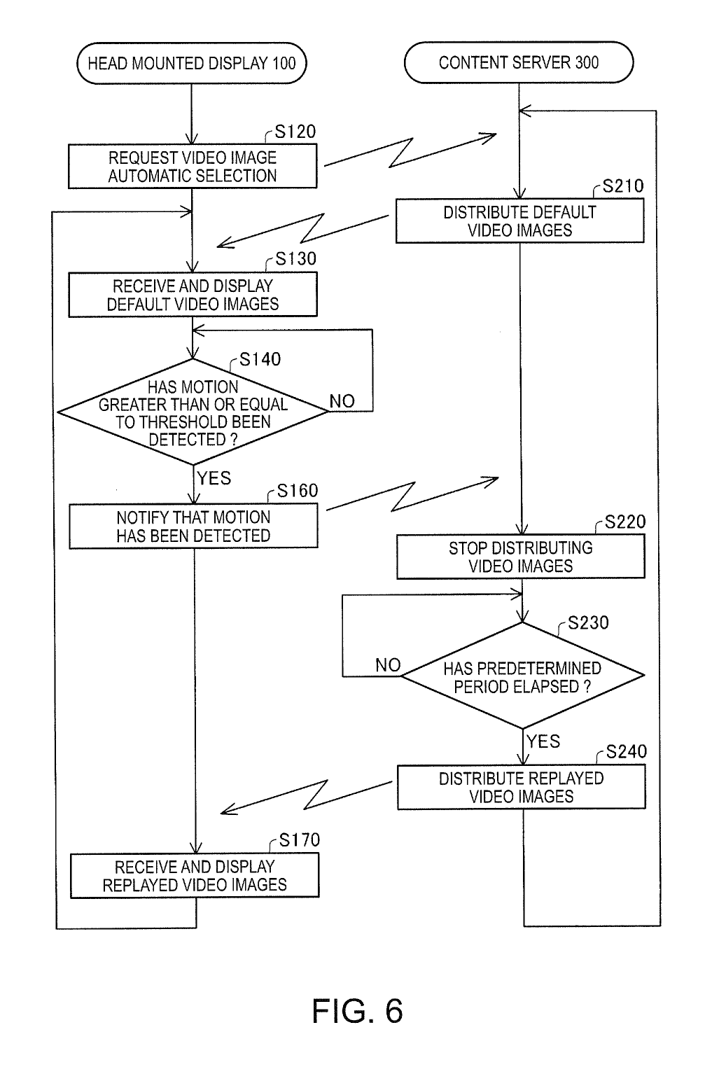

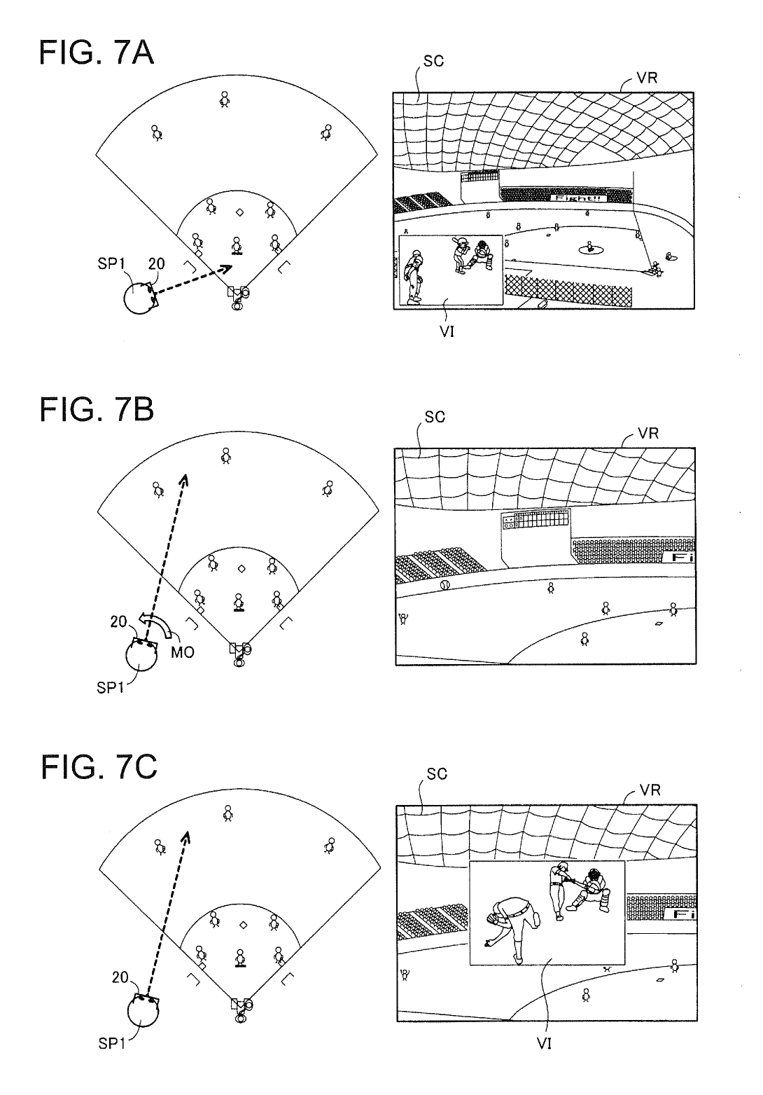

Further, when the user selects the automatic button, an automatic video image selection process described below starts. The automatic video image selection process is a process in which the content server 300 automatically selects video images and distributes the selected video images to the head mounted display 100 and the head mounted display 100 displays the distributed video images. FIG. 6 is a flowchart showing the procedure of the automatic video image selection process. FIGS. 7A to 7C are descriptive diagrams showing a summary of the automatic video image selection process. FIG. 7A shows that the spectator SP1 is sitting on an infield seat in the watching area ST and watching a baseball game. In a baseball game, a spectator SP typically directs the line of sight toward an area between a pitcher and a catcher (battery) or therearound in many cases, as shown in FIG. 7A.

When the automatic video image selection process starts, the game watch assistant 142 of the head mounted display 100 transmits a request for the video image automatic selection to the content server 300 via the wireless communication section 132 (step S120). At this point, the game watch assistant 142 also transmits positional information representing the current position detected with the GPS module 134 to the content server 300. The video image distributor 316 of the content server 300 having received the request for the video image automatic selection reads default video images from the storage section 320 set in advance in accordance with the position among the positions (or the area among the areas, the same holds true in the following description) in the watching area ST and distributes the read video images to the head mounted display 100 via the wireless communication section 330 (step S210). The game watch assistant 142 of the head mounted display 100 receives the distributed default video images via the wireless communication section 132 and displays the default video images as the virtual image VI (step S130).

In the present embodiment, video images generated by capturing images of an object at an angle different from the angle of the line of sight from each seat in the watching area ST by at least a predetermined value are set as the default video images. For example, realtime video images captured with the camera Ca1 (center field camera) shown in FIG. 1 are set as the default video images corresponding to the position of each infield seat in the watching area ST, as shown, for example, in FIG. 7A. In this case, the realtime video images captured with the center field camera are visually recognized as the virtual image VI in the field of view VR of the spectator SP1. Since the default video images set as described above allow the spectator SP to visually recognize the virtual image VI formed of video images differently angled from the outside scene SC, which is directly visually recognized, the spectator SP can watch the game in a more enjoyable manner. The video images generated by capturing images of an object at an angle different from the angle of the line of sight of the user by at least a predetermined value mean that the angle between the light of sight and the optical axis direction of the image capturing camera is at least a predetermined value. The predetermined value, which can be arbitrarily set, is preferably, for example, at least 15 degrees, more preferably at least 30 degrees, still more preferably at least 45 degrees from the viewpoint of enhancement of the direct field of view of the user. Further, the virtual image VI formed of the default video images is visually recognized in a relatively small area in a position relatively far away from the center of the field of view VR of the spectator SP, as shown in FIG. 7A. The virtual image VI in the field of view VR of the spectator SP therefore occupies only a small area at the periphery of the field of view VR, whereas the outside scene SC, which is directly visually recognized, occupies the most of the field of view VR. The virtual image VI therefore compromises a sense of realism of the game watching user to the least possible extent.

The game watch assistant 142 of the head mounted display 100 monitors whether or not the nine-axis sensor 66 has detected a motion of the user's head greater than or equal to a threshold set in advance (hereinafter referred to as “large head motion MO”) (step S140). When a large head motion MO is detected, the game watch assistant 142 notifies the content server 300 that the large head motion MO has been detected (step S160). The notification corresponds to motion information representing a motion of the user's head. When the information receiver 312 of the content server 300 receives the notification via the wireless communication section 330, the video image distributor 316 stops distributing video images to the head mounted display 100 from which the notification has been transmitted (step S220). As a result, the user of the head mounted display 100 does not visually recognize the virtual image VI any more. FIG. 7B shows that the spectator SP1 has moved the head by a large amount toward the outfield because a batter has hit a ball toward the outfield. The threshold described above is so set that a value detected with the nine-axis sensor 66 when the spectator SP makes such a large head motion MO is greater than the threshold. In the case shown in FIG. 7B, the content server 300 therefore stops distributing video images to the head mounted display 100, and the field of view VR of the spectator SP1 contains no virtual image VI.

In general, it is conceivable that a spectator SP who is watching a sport game moves the head by a large amount when some important play worth watching (a play in which a batter has successfully hit a ball with a bat, for example) is done in many cases. When such a play is done, it is conceivable that each spectator SP desires to directly watch the play. In the present embodiment, when a large head motion MO of a spectator SP is detected, the content server 300 stops distributing video images to the head mounted display 100 and the field of view VR of the spectator SP contains no virtual image VI any more, whereby the spectator SP can visually recognize an important play worth watching in the entire field of view VR without the play blocked by the virtual image VI. The video image display system 1000 according to the present embodiment can thus enhance the convenience of the user.

The video image distributor 316 of the content server 300 monitors whether or not a preset period has elapsed since the reception of the notification from the head mounted display 100 (step S230). The period is set as appropriate in accordance with characteristics of each sport (an average period required for a single play, for example). Before the preset period elapses, the content server 300 keeps stopping video image distribution to the head mounted display 100. After the preset period elapses, the content server 300 determines a replay period based on the notification described above, reads replayed video images within the determined period from the storage section 320, and distributes the read video images to the head mounted display 100 (step S240). In the present embodiment, a period having a predetermined length containing the timing at which the notification from the head mounted display 100 is received is set as the replay period. Setting the period as described above allows the replayed video imaged selected by the content server 300 to be those in a period containing the timing at which the large head motion MO of the spectator SP is detected, whereby the replayed video images contain an important play worth watching. In the present embodiment, replayed video images are distributed as described above on the assumption that after the preset period elapses since the reception of the notification from the head mounted display 100, an important play worth watching has been completed and the user desires to watch replayed video images of the play.

The game watch assistant 142 of the head mounted display 100 receives the distributed replayed video images and displays the received replayed video images as the virtual image VI (step S170). FIG. 7C shows that the replayed video images are visually recognized as the virtual image VI in the field of view VR of the user. The virtual image VI formed of the replayed video images is visually recognized in a larger area in a position closer to the center of the field of view VR of the spectator SP than the virtual image VI formed of the default video images described above. The spectator SP can therefore visually recognize the replayed video images of an important play worth watching in a large central area of the field of view VR. The video image display system 1000 according to the present embodiment can thus further enhance the convenience of the user.

Upon completion of the distribution of the replayed video images, the content server 300 starts distributing the default video images again (step S210). The steps described above are repeatedly carried out afterward.

As described above, in the automatic video image selection process in the video image display system 1000 according to the present embodiment, when the nine-axis sensor 66 in any of the head mounted displays 100 present in the baseball stadium BS detects a large head motion MO, the game watch assistant 142 of the head mounted display 100 transmits motion information representing that the large head motion MO has been detected to the content server 300. The video image distributor 316 of the content server 300 having received the motion information selects replayed video images based on the motion information and distributes the selected video images to the head mounted display 100. In the thus configured video image display system 1000 according to the present embodiment, preferable video images according to the state of the user are selected and the head mounted display 100 displays the selected video images without forcing the user of the head mounted display 100 to make cumbersome video image selection, whereby the convenience of the user can be enhanced.

### B. Second Embodiment

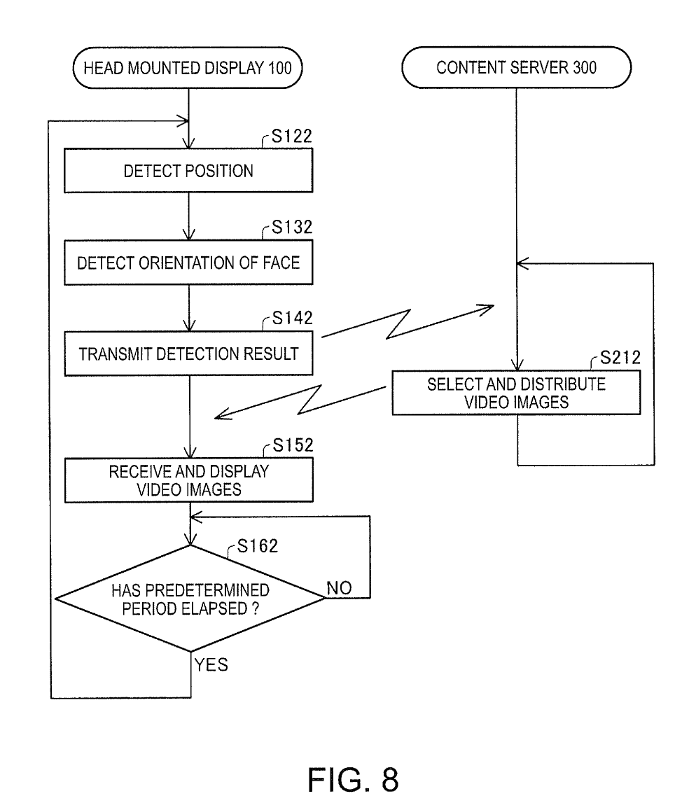

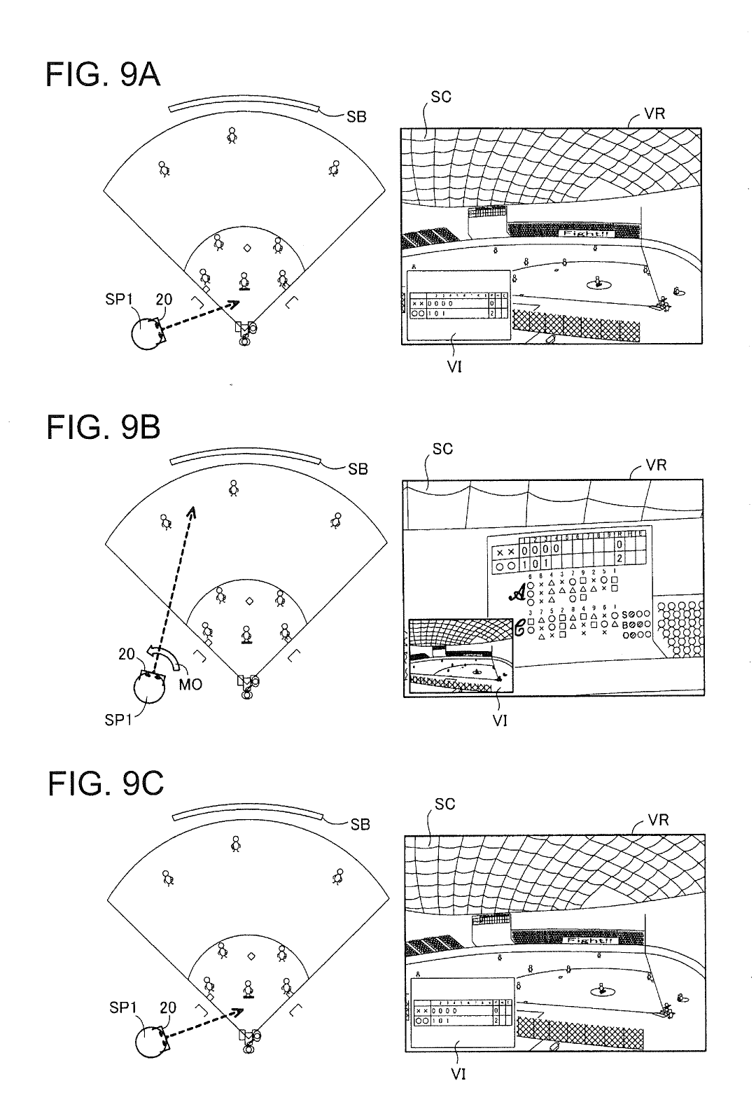

FIG. 8 is a flowchart showing the procedure of an automatic video image selection process in a second embodiment. FIGS. 9A to 9C are descriptive diagrams showing a summary of the automatic video image selection process in the second embodiment. FIG. 9A shows that the spectator SP1 is sitting on an infield seat in the watching area ST and watching a baseball game, as in FIG. 7A.

When the automatic video image selection process starts, the game watch assistant 142 (FIG. 3) of the head mounted display 100 instructs the GPS module 134 to detect the current position (step S122), instructs the nine-axis sensor 66 to detect the orientation of the user's face (step S132), and transmits positional information representing the current position and motion information representing the orientation of the face to the content server 300 via the wireless communication section 132 (step S142).

The video image distributor 316 of the content server 300 having received the positional information and the motion information selects video images to be distributed to the head mounted display 100 based on the positional information and the motion information, reads the selected video images from the storage section 320, and distributes the read video images to the head mounted display 100 (step S212). The game watch assistant 142 of the head mounted display 100 receives the video images distributed from the content server 300 via the wireless communication section 132 and displays the received video images as the virtual image VI (step S152).

In the present embodiment, the video image distributor 316 of the content server 300 estimates the line of sight of the user of the head mounted display 100 based on the positional information, which identifies the current position of the head mounted display 100, and the motion information, which identifies the orientation of the face of the user of the head mounted display 100 and selects video images generated by capturing images of an object at an angle different from the angle of the estimated line of sight by at least a predetermined value as video images to be distributed to the head mounted display 100. The predetermined value is set in advance in the same manner as in the first embodiment described above. For example, in the case shown in FIG. 9A, the orientation of the line of sight estimated from not only the position of the spectator SP1 but also the orientation of the face of the spectator SP1 is oriented from the position of the spectator SP1 toward a position in the vicinity of the battery. The video image distributor 316 therefore selects, as images to be distributed, video images generated by capturing images of an object at an angle different from the angle of the estimated line of sight by at least the predetermined value, for example, video images generated by capturing images of the scoreboard SB with the camera Ca4 (FIG. 1) behind the backstop. When the thus selected video images are distributed to the head mounted display 100 mounted on the spectator SP1, the video images generated by capturing images of the scoreboard SB are visually recognized as the virtual image VI in the field of view VR of the spectator SP1, as shown in FIG. 9A. The spectator SP1 can therefore visually recognize the scoreboard SB as the virtual image VI while directly visually recognizing plays of the players as the outside scene SC. The video image display system 1000 according to the present embodiment can thus enhance the convenience of the user.

The game watch assistant 142 of the head mounted display 100 monitors whether or not a predetermined period has elapsed since the reception of the video images (step S162). After the predetermined period elapses, the game watch assistant 142 detects the current position (step S122) and the orientation of the user's face (step S132) again and transmits the positional information and the motion information to the content server 300 (step S142). The video image distributor 316 of the content server 300 having received the positional information and the motion information selects video images to be distributed to the head mounted display 100 based on the newly received positional information and motion information and distributes the selected video images to the head mounted display 100 (step S212). For example, when the spectator SP1 changes his/her state shown in FIG. 9A by making a motion MO that orients the head toward the scoreboard SB as shown in FIG. 9B, the video image distributor 316 selects, as images to be distributed, video images generated by capturing images of an object at an angle different from the angle of the line of sight of the spectator SP1 by at least the predetermined value, for example, video images captured with the camera Ca5 (FIG. 1), which is located in a position in the vicinity of the current position of the spectator SP1, oriented toward the battery. When the thus selected video images are distributed to the head mounted display 100 mounted on the spectator SP1, video images generated by using the camera in the vicinity of the current position of the spectator SP1 to capture images of the ground GR are visually recognized as the virtual image VI in the field of view VR of the spectator SP1. The spectator SP1 can therefore visually recognize video images corresponding to an estimated field of view VR of the spectator SP1 who hypothetically faces the battery as the virtual image VI while directly visually recognizing the scoreboard SB as the outside scene SC. The video image display system 1000 according to the present embodiment can thus enhance the convenience of the user.

Afterward, when the spectator SP1 moves the head from the state shown in FIG. 9B and returns the line of sight to a position in the vicinity of the battery as shown in FIG. 9C, the video image distributor 316 selects, as images to be distributed, video images generated by capturing images of an object at an angle different from the angle of the light of sight of the spectator SP1 by at least the predetermined value, for example, video images generated by using the camera Ca4 behind the backstop to capture images of the scoreboard SB. When the thus selected video images are distributed to the head mounted display 100 mounted on the spectator SP1, the state of the field of view VR of the spectator SP1 returns to the state before the spectator SP1 moves the head toward the scoreboard SB (state shown in FIG. 9A).

As described above, in the automatic video image selection process in the video image display system 1000 according to the second embodiment, when the GSP module 134 detects the current position and the nine-axis sensor 66 detects the orientation of the head in the head mounted display 100, the game watch assistant 142 of the head mounted display 100 transmits the positional information and the motion information to the content server 300. The video image distributor 316 of the content server 300 having received the positional information and the motion information selects video images to be distributed to the head mounted display 100 based on the positional information and the motion information. Specifically, the video image distributor 316 of the content server 300 selects, as video images to be distributed to the head mounted display 100, video images generated by capturing images of an object at an angle different from the angle of a line of sight of the user of the head mounted display 100 estimated based on the motion information and the positional information by at least the predetermined value. In the thus configured video image display system 1000 according to the second embodiment, preferable video images according to the state of the user are selected and the head mounted display 100 displays the selected video images without forcing the user of the head mounted display 100 to make cumbersome video image selection, whereby the convenience of the user can be enhanced.

### C. Variations

The invention is not limited to the embodiments described above and can be implemented in a variety of other aspects to the extent that they do not depart from the substance of the invention. For example, the following variations are conceivable:

### C1. Variation 1

In the embodiments described above, the video image display system 1000 is used in the baseball stadium BS. The video image display system 1000 can also be used in other geographic regions. Examples of the other geographic regions include stadiums for other sports (soccer stadium, for example), museums, exhibition halls, concert halls, and theaters. When the video image display system 1000 is used in stadiums for other sports, concert halls, and theaters, and a large head motion MO of a user is detected, the video image display system 1000 can stop distributing video images and then distribute replayed video images to enhance the convenience of the user, as in the first embodiment described above. Further, when the video image display system 1000 is used in stadiums for other sports, concert halls, theaters, museums, and exhibition halls, the video image display system 1000 can distribute video images generated by capturing images of an object at an angle different from the angle of an estimated line of sight of the user by at least a predetermined value to enhance the convenience of the user, as in the second embodiment described above.

Further, in the automatic video image selection process in each of the embodiments described above, a virtual image VI formed in one area of the field of view VR of the user is visually recognized. Alternatively, a virtual image VI formed in at least two areas of the field of view VR of the user may be visually recognized. For example, in the case shown in FIG. 7A, a virtual image VI formed in two areas, not only the area in the vicinity of the lower left corner of the field of view VR of the user but also an additional area in the vicinity of the upper right corner, may be visually recognized. When a virtual image VI formed in at least two areas is visually recognized as described above, video images to be formed in each of the areas may also be selected based on motion information and positional information. Further, in this case, differently angled video images may be formed or differently zoomed video images may be formed in the areas that form the virtual image VI.

### C2. Variation 2

In the embodiments described above, the content server 300 selects video images to be distributed to each head mounted display 100 from multiple sets of video images. Alternatively, the content server 300 may distribute multiple sets of video images to each head mounted display 100, and the head mounted display 100 may select video images to be visually recognized by the user as the virtual image VI from the distributed video images. The selection of video images made by the head mounted display 100 can be the same as the selection of video images made by the content server 300 in the embodiments described above.

### C3. Variation 3

The configuration of the head mounted display 100 in the embodiments described above is presented only by way of example, and a variety of variations are conceivable. For example, the cross-shaped key 16 and the tough pad 14 provided on the control unit 10 may be omitted, or in addition to or in place of the cross-shaped key 16 and the tough pad 14, an operation stick or any other operation interface may be provided. Further, the control unit 10 may be so configured that a keyboard, a mouse, and other input devices can be connected to the control unit 10 and inputs from the keyboard and the mouse are accepted.

Further, as the image display unit, the image display unit 20, which is worn as if it were glasses, may be replaced with an image display unit based on any other method, such as an image display unit worn as if it were a hat. Moreover, the earphones 32 and 34, the camera 61, and the GPS module 134 can be omitted as appropriate. Further, in the embodiments described above, LCDs and light sources are used to generate image light. The LCDs and the light sources may be replaced with other display devices, such as organic EL displays. Moreover, in the embodiments described above, the nine-axis sensor 66 is used as a sensor that detects motion of the user's head. The nine-axis sensor 66 may be replaced with a sensor formed of one or two of an acceleration sensor, an angular velocity sensor, and a terrestrial magnetism sensor. Further, in the embodiments described above, the OPS module 134 is used as a sensor that detects the position of the head mounted display 100. The GPS module 134 may be replaced with another type of position detection sensor. Moreover, each seat in the baseball stadium BS may be provided with the head mounted display 100, which may store positional information that identifies the position of the seat in advance. Further, in the embodiments described above, the head mounted display 100 is of a binocular, optically transmissive type. The invention is similarly applicable to head mounted displays of other types, such as a video transmissive type and a monocular type.

Further, in the embodiments described above, the head mounted display 100 may guide image light fluxes representing the same image to the right and left eyes of the user to allow the user to visually recognize a two-dimensional image or guide image light fluxes representing different images to the right and left eyes of the user to allow the user to visually recognize a three-dimensional image.

Further, in the embodiments described above, part of the configuration achieved by hardware may be replaced with a configuration achieved by software, or conversely, part of the configuration achieved by software may be replaced with a configuration achieved by hardware. For example, in the embodiments described above, the image processor 160 and the audio processor 170 are achieved by a computer program read and executed by the CPU 140, and these functional portions may be achieved by hardware circuits.

Further, when part or the entire of the functions of the embodiments of the invention is achieved by software, the software (computer program) can be provided in the form of a computer-readable storage medium on which the software is stored. The “computer-readable storage medium” used in the invention includes not only a flexible disk, a CD-ROM, and any other portable storage medium but also an internal storage device in a computer, such as a variety of RAMs and ROMs, and an external storage device attached to a computer, such as a hard disk drive.

### C4. Variation 4

In the first embodiment described above, video images generated by capturing images of an object at an angle different from the angle of the line of sight of a person in each position in the watching area ST by at least a predetermined value are set as the default video images. Other video images may alternatively be set as the default video images. For example, video images captured at the same angle as or an angle similar to the angle of the line of sight of a person in each position in the watching area ST may be set as the default video images. Alternatively, the default video images may be set irrespective of the positions in the watching area ST. Further, among video images corresponding to the baseball stadium BS, video images other than those generated by capturing images of an object in the baseball stadium BS (player information video images, for example) may be set as the default video images. When the positional information representing the current position of each head mounted display 100 is not required to select video images to be distributed to the head mounted display 100, the positional information is not necessarily transmitted from the head mounted display 100 to the content server 300.

Further, in the first embodiment described above, when a large head motion MO of a spectator SP is detected, the head mounted display 100 notifies the content server 300 of the detection, and the content server 300 having received the notification stops distributing default video images to the head mounted display 100. Alternatively, the distribution of the default video images may be continued. In this case as well, switching video images being distributed from the default video images to replayed video images after a predetermined period elapses since the notification allows the spectator SP to visually recognize the replayed video images of an important play worth watching in a large area, whereby the convenience of the user can be enhanced.

Further, in the first embodiment described above, when a large head motion MO of a spectator SP is detected, the head mounted display 100 notifies the content server 300 of the detection, and the content server 300 having received the notification stops distributing video images to the head mounted display 100. Alternatively, when a large head motion MO of a spectator SP is detected, the head mounted display 100 itself may switch its display mode to a mode in which no virtual image VI is displayed. That is, the head mounted display 100 may not display the distributed video images as the virtual image VI while it keeps receiving video images distributed from the content server 300. In this case as well, when the head mounted display 100 notifies the content server 300 of the detection, the content server 300 can distribute replayed video images in place of default video images to the head mounted display 100 after a predetermined period elapses since the notification. The head mounted display 100 to which the replayed video images are distributed displays the distributed video images as the virtual image VI. In this case as well, the spectator SP is allowed to visually recognize an important play worth watching in the entire field of view VR without the important play blocked by the virtual image VI, and the spectator SP is then allowed to visually recognize replayed video images of the important play worth watching, whereby the convenience of the user can be enhanced.

Further, in the first embodiment described above, when a large head motion MO of a spectator SP is detected in the head mounted display 100, the head mounted display 100 notifies the content server 300 that the large head motion MO has been detected. Alternatively, detected values from the nine-axis sensor 66 in the head mounted display 100 may be continuously transmitted to the content server 300, and the content server 300 may determine whether or not the spectator SP has made any large head motion MO. Detected values from the nine-axis sensor 66 correspond to motion information representing motion of the user's head. In this case as well, when the content server 300 determines that the spectator SP has made a large head motion MO, the content server 300 stops distributing default video images and distributes replayed video images after a predetermined period elapses to allow the spectator SP to visually recognize an important play worth watching in the entire field of view VR without the important play blocked by the virtual image VI and then allow the spectator SP to visually recognize replayed video images of the important play worth watching in the large area, whereby the convenience of the user can be enhanced.

Further, in the first embodiment described above, a period having a predetermined length containing the timing at which notification (motion information) from any of the head mounted displays 100 is received is set as the replay period, but the replay period is not necessarily set this way. For example, when the notification contains information that identifies the timing at which a large head motion of the user is detected, a period having a predetermined length containing the timing may be set as the replay period.

Further, in the first embodiment described above, a virtual image VI formed of replayed video images is visually recognized in a larger area in a position closer to the center of the field of view VR of a spectator SP than a virtual image VI formed of default video images, but the virtual image VI formed of replayed video images is not necessarily visually recognized this way. For example, the virtual image VI formed of replayed video images may be visually recognized in a position closer to the center of the field of view VR of the spectator SP than the virtual image VI formed of default video images, but the area where the replayed video images are visually recognized may be equal to or smaller than the area where the default video images are visually recognized. Further, the virtual image VI formed of replayed video images may be visually recognized in a larger area in the field of view VR of the spectator SP than the virtual image VI formed of default video images, but the distance from the center of the field of view VR to the area where the replayed video images are visually recognized may be equal to or longer than the distance to the area where the default video images are visually recognized. Moreover, the virtual image VI formed of replayed video images may be displayed in the field of view VR of the spectator SP after enhanced as compared with the virtual image VI formed of default video images. Examples of the enhanced display are as follows: Replayed video images are made brighter than the other areas; Replayed video images are displayed in an area surrounded by a highly visible frame (such as thick frame, frame having complicated shape, and frame having a higher contrast color than surrounding colors); and replayed video images are displayed in a moving area. Further, the virtual image VI formed of replayed video images may be labeled with a predetermined mark that is not added to the virtual image VI formed of default video images in the field of view VR of the spectator SP. The predetermined mark may be a mark or a tag indicating that the virtual image VI is formed of replayed video images, a moving mark, or any other suitable mark.

### C5. Variation 5

In the second embodiment described above, the video image distributor 316 of the content server 300 selects, as video images to be distributed to a head mounted display 100, video images generated by capturing images of an object at an angle different from the angle of a line of sight of the user estimated based on positional information and motion information, but the video images are not necessarily selected this way. For example, the video image distributor 316 may estimate the field of view of the user based on positional information and motion information and select video images generated by capturing images of an object located outside the estimated field of view of the user. The user can thus visually recognize, as the virtual image VI, the video images of the object different from an object that the user directly visually recognizes as the outside scene SC. Alternatively, the video image distributor 316 may select video images generated by capturing images of an object located outside a predetermined area in the estimated field of view of the user (an area in the vicinity of the center of the field of view, for example). The user can thus visually recognize, as the virtual image VI, the video images of the object different from an object that the user directly visually recognizes as the outside scene SC in the predetermined area of the field of view VR.

### C6. Variation 6

In the embodiments described above, video images to be distributed are selected based on notification indicating that a large head motion MO has been detected (motion information). Alternatively, video images to be distributed may be selected with no motion information used but based on positional information representing the current position detected with the GPS module 134. For example, the baseball stadium BS may be divided into a plurality of areas (ten areas from area A to area J, for example), and video images most suitable for the area determined based on the positional information (video images showing a scene of a home run, video images showing the number on the uniform of a player far away and hence not in the sight of the spectators in the area, video images showing the name of a player of interest, video images showing a scene of a hittable ball, and video images showing actions of reserve players, for example) may be selected and distributed. The positional information is not necessarily detected with the GPS module 134 but may be detected in other ways. For example, the camera 61 may be used to recognize the number of the seat on which the user is sitting for more detailed positional information detection. The detection described above allows an ordered item to be reliably delivered, information on user's surroundings to be provided, and advertisement and promotion to be effectively made.

### C7. Variation 7

In the embodiments described above, the content server 300 is used to distribute video images. Any information apparatus capable of distributing video images other than the content server 300 may alternatively be used. For example, when video images captured with the cameras Ca are not recorded but distributed to each head mounted display 100 in realtime over radio waves, a communication network, or any other medium, each of the cameras Ca is configured to have the distribution capability so that it functions as an information apparatus that distributes video images (or a system formed of the cameras Ca and a distribution device function as an information apparatus that distributes video images).

### C8. Variation 8

In the embodiments described above, when displayed video images are switched to other video images, for example, because a large motion is detected, the degree of see-through display may be changed by changing the display luminance of the backlights or any other display component. For example, when the luminance of the backlights is increased, the virtual image VI is enhanced, whereas when the luminance of the backlights is lowered, the outside scene SC is enhanced.

Further, in the embodiments described above, when a large motion is detected, for example, displayed video images may not be switched to other video images but the size and/or position of the displayed video images may be changed. For example, the displayed video images may not be changed but may be left at a corner of the screen as in wipe display, and the left video images may be scaled in accordance with the motion of the head.

### C9. Variation 9

For example, the image light generation unit may alternatively include an organic EL (electro-luminescence) display and an organic EL control section. Further, the image generator may be a LCOS® (liquid crystal on silicon, LCoS is a registered trademark) device, a digital micromirror device, or any other suitable device in place of each of the LCDs. The invention is also applicable to a head mounted display using a laser-based retina projection method. In the laser-based retina projection method, the “area through which image light can exit out of the image light generation unit” can be defined to be an image area recognized with the user's eyes.

Further, for example, the head mounted display may alternatively be so configured that the optical image display sections cover only part of the user's eyes, in other words, the optical image display sections do not fully cover the user's eyes. Moreover, the head mounted display may be of what is called a monocular type.

Further, as the image display unit, the image display unit worn as if it were glasses may be replaced with an image display unit worn as if it were a hat or an image display unit having any other shape. Moreover, each of the earphones may be of an ear-hanging type or a headband type or may even be omitted. Further, for example, the head mounted display may be configured as a head mounted display provided in an automobile, an airplane, and other vehicles. Moreover, for example, the head mounted display may be built in a helmet or any other body protection gear.

The entire disclosure of Japanese Patent Application No. 2012-213016, filed Sep. 26, 2012 is expressly incorporated by reference herein.

What is claimed is:

1. A video image display system comprising:
an information apparatus; and
a transmissive head mounted display that allows a user to visually recognize video images distributed from the information apparatus as virtual images,
wherein the information apparatus includes a video image distributor that distributes video images corresponding to a specific geographic region to the head mounted display, and
the head mounted display includes a motion detector that detects motion of the user's head and allows the user to visually recognize, as virtual images, the video images selected based on motion information representing the motion.

2. The video image display system according to claim 1,
wherein the head mounted display includes an information transmitter that transmits the motion information to the information apparatus,
the information apparatus includes an information receiver that receives the motion information from the head mounted display located in the specific geographic region, and
the video image distributor selects at least one of the multiple sets of video images corresponding to the specific geographic region based on the motion information and distributes the selected video images to the head mounted display from which the motion information has been transmitted.

3. The video image display system according to claim 2,
wherein the multiple sets of video images include replayed video images generated by capturing images of an object in the specific geographic region in a predetermined period, and
when the motion of the user's head represented by the motion information is greater than or equal to a threshold set in advance, the video image distributor selects the replayed video images corresponding to a period determined based on the motion information.

4. The video image display system according to claim 3,
wherein the replayed video images are visually recognized in a position closer to the center of the field of view of the user of the head mounted display than the other video images.

5. The video image display system according to claim 3,
wherein the replayed video images are displayed in the field of view of the user of the head mounted display in at least one of the manners that the replayed video images are enlarged, the replayed video images are enhanced, and the replayed video images are provided with a predetermined mark, as compared with the other video images.

6. The video image display system according to claim 2,
wherein the video image distributor stops distributing video images for a predetermined period to the head mounted display from which the motion information has been transmitted when the motion of the user's head represented by the motion information is greater than a threshold set in advance.

7. The video image display system according to claim 2,
wherein the multiple sets of video images are generated by capturing images of an object in the specific geographic region,
the head mounted display further includes a position detector that detects a current position,
the information transmitter transmits positional information representing the current position to the information apparatus, and
the video image distributor selects video images based on the motion information and the positional information.

8. The video image display system according to claim 7,
wherein the video image distributor selects video images generated by capturing images of an object at an angle different from the angle of a line of sight of the user of the head mounted display estimated based on the motion information and the positional information by at least a predetermined value.

9. The video image display system according to claim 7,
wherein the video image distributor selects video images generated by capturing images of an object located outside a predetermined area in a field of view of the user of the head mounted display estimated based on the motion information and the positional information.

10. The video image display system according to claim 1,
wherein the head mounted display in the specific geographic region includes
a video image receiver that receives the multiple sets of video images corresponding to the specific geographic region from the information apparatus, and
a video image selector that selects video images to be visually recognized by the user from the multiple sets of video images based on the motion information.

11. A transmissive head mounted display to which an information apparatus distributes video images corresponding to a specific geographic region and which allows a user to visually recognize the distributed video images as virtual images, the head mounted display comprising a motion detector that detects motion of the user's head and allows the user to visually recognize, as virtual images, the video images selected based on motion information representing the motion.

12. A video image display system comprising:
an information apparatus; and
a transmissive head mounted display that allows a user to visually recognize video images distributed from the information apparatus as virtual images,
wherein the head mounted display includes
a position detector that detects a current position, and
an information transmitter that transmits positional information representing the current position to the information apparatus, and
the information apparatus includes
an information receiver that receives the positional information from the head mounted display located in a specific geographic region, and
a video image distributor that selects at least one of multiple sets of video images corresponding to the specific geographic region based on the positional information and distributes the selected video images to the head mounted display from which the positional information has been transmitted.
